(19) United States
(12) Patent Application Publication
(10) Pub. No.: US 2026/0181700 A1
(43) Pub. Date: Jun. 25, 2026

(54) PHYSICAL DOWNLINK CHANNEL CONTROL CHANNEL ORDER IN CASE OF DYNAMIC ADAPTATION OF PHYSICAL RANDOM ACCESS CHANNEL

(71) Applicant: QUALCOMM Incorporated, San Diego, CA (US)

(72) Inventors: Mohammed JABI, San Diego, CA (US); Ahmed Attia ABOTABL, San Diego, CA (US)

(21) Appl. No.: 18/988,692

(22) Filed: Dec. 19, 2024

(51) Int. Cl. H04W 74/0833; H04W 74/00

(52) U.S. Cl. CPC H04W 74/0833; H04W 74/006

(57) ABSTRACT

Certain aspects of the present disclosure provide techniques for wireless communications. An example method includes receiving a first configuration of one or more first random access channel (RACH) occasions (ROs); receiving an indication to activate one or more additional ROs in addition to the one or more first ROs; receiving a physical downlink control channel (PDCCH) order comprising a physical random access channel (PRACH) mask index and a synchronization signal block (SSB) index; and transmitting a PRACH preamble on a selected RO from a subset of ROs mapped to the SSB index and indicated by the PRACH mask index, wherein the subset of ROs from which the selected RO is selected are identified according to one or more association rules for the PDCCH order.

### INTRODUCTION

### Field of the Disclosure

Aspects of the present disclosure relate to wireless communications, and more particularly, to techniques to support dynamic adaptation of physical random access channel in time domain.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by an apparatus. The method includes receiving a first configuration of one or more first random access channel (RACH) occasions (ROs); receiving an indication to activate one or more additional ROs in addition to the one or more first ROs; receiving a physical downlink control channel (PDCCH) order comprising a physical random access channel (PRACH) mask index and a synchronization signal block (SSB) index; and transmitting a PRACH preamble on a selected RO from a subset of ROs mapped to the SSB index and indicated by the PRACH mask index, wherein the subset of ROs from which the selected RO is selected are identified according to one or more association rules for the PDCCH order.

Certain aspects provide a method for wireless communications by a network entity. The method includes transmitting a first configuration of one or more first ROs; transmitting an indication to activate one or more additional ROs in addition to the one or more first ROs; transmitting a PDCCH order comprising a PRACH mask index and a SSB index; and receiving a PRACH preamble on a selected RO from a subset of ROs mapped to the SSB index and indicated by the PRACH mask index, wherein the subset of ROs from which the selected RO is selected are identified according to one or more association rules for the PDCCH order.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5A depicts a process flow diagram of an example four-step random access channel (RACH) procedure performed between a UE and a network entity.

FIG. 5B depicts a process flow diagram of an example two-step RACH procedure performed between the UE and the network entity.

FIG. 6 illustrates an example mapping of synchronization signal blocks (SSBs) to physical random access channel (PRACH) occasions (ROs).

FIG. 7 depicts a process flow for communications in a network between a network entity and a UE.

FIG. 8 is a diagram illustrating an example of signaling, interpretation of ROs and indications of dynamic adaptations of PRACH.

FIG. 9 is a diagram illustrating an example of ROs for dynamic adaptations of PRACH.

FIG. 10 is a diagram illustrating an example of mapping and remapping SSB to RO for dynamic adaptations of PRACH.

FIG. 11 depicts a method for wireless communications.

FIG. 12 depicts another method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums to support dynamic adaptation of physical random access channel in time domain.

A UE of a wireless communication network may perform a random access channel (RACH) procedure for various purposes, such as initial access, synchronization, random-access-based handover, or connection reestablishment. A RACH procedure involves the transmission of a RACH preamble on a time-frequency resource configured for a device to perform a RACH procedure, referred to herein as a RACH occasion (RO) or a physical RACH (PRACH) occasion. A UE may be configured with a number of ROs, and different ROs may be associated with different parameters, such as different synchronization signal blocks (SSBs). A RACH procedure may be performed using a PRACH, such as by transmitting a PRACH preamble on an RO via the PRACH. In some contexts, “RACH” and “PRACH” may be used interchangeably.

ROs may generally be semi-statically configured, such as via radio resource control (RRC) signaling or system information broadcast. In some examples, one or more of these occasions may be configured for a large number of UEs. In some examples, ROs may be subject to PRACH adaptation, in which a number of ROs configured for a UE (or another parameter of the ROs) may be changed after initial configuration of the number of ROs. For example, the development of network energy saving techniques continues to be a focus for hardware providers and operators. Many studies focus on enhancements of network energy savings techniques in the time domain, frequency domain, spatial domain, and power domain to reduce energy from the network side. For example, the enhancements of network energy savings for New Radio (NR) targets include specifying adaptation of common signal/channel transmissions including adaptations of SSB in time domain (for example, adapting periodicity of the SSB), adaptation of PRACH signaling in the time domain, adaptation of PRACH signaling in the spatial domain, adaptation of paging occasions (including confining the paging occasions in the time domain), or the like. Aspects of the present application relate to enhancements in energy savings with respect to adaptation of PRACH signaling in the time domain.

Dynamic adaptation of PRACH in the time domain refers to the configuration, activation, or deactivation of additional PRACH resources (e.g. additional ROs) in addition to a first set of PRACH resources (e.g., first ROs). The first set of PRACH resources may be indicated via system information, configuration information, or the like. The additional PRACH resources can be activated/deactivated in a fast and dynamic manner, such as via downlink control information (DCI) or other dynamic signaling. In some examples, PRACH adaptation may be signaled via a paging early indication (PEI) and/or a paging DCI message. For example, a PEI and/or a paging DCI message may indicate the adaptation of PRACH resources in the time domain by indicating availability of additional PRACH resources.

A PDCCH order is sent by the network, for example, to trigger a UE to re-establish UE synchronization. A PDCCH order initiates a Random Access procedure of an RRC-connected-mode UE. The PDCCH order is transmitted using a DCI format (such as DCI format 1_0) with the frequency-domain allocation field bits set to 1 and cyclic redundancy check (CRC) bits scrambled using a cell radio network temporary identifier (C-RNTI). The DCI format includes one or more PRACH mask indexes, which indicate the ROs associated with the specified SSB (indicated by an SSB index) for the PRACH transmission of the contention-free random access resources. The DCI format also includes the SSB index. For example, a PRACH mask index may indicate a subset of ROs from a RACH configuration (either a dedicated RACH configuration such as rach-ConfigDedicated or a common RACH configuration such as rach-ConfigCommon). The PRACH mask index field may be 4 bits. Table 1, below, illustrates an example of the ROs available for each PRACH mask index value. The PRACH mask index and the allowed RO(s) of the SSB will be discussed in more detail herein.

TABLE 1

| | Allowed PRACH occasion(s) (RO(s)) of |
|---|---|
| PRACH Mask Index | SSB |
| 0 | All |
| 1 | PRACH occasion index 1 |
| 2 | PRACH occasion index 2 |
| 3 | PRACH occasion index 3 |
| 4 | PRACH occasion index 4 |
| 5 | PRACH occasion index 5 |
| 6 | PRACH occasion index 6 |
| 7 | PRACH occasion index 7 |
| 8 | PRACH occasion index 8 |
| 9 | Every even PRACH occasion |
| 10 | Every odd PRACH occasion |
| 11 | Reserved |
| 12 | Reserved |
| 13 | Reserved |
| 14 | Reserved |
| 15 | Reserved |

However, technical challenges arise with how to handle interpretation of a PRACH mask index in a PDCCH order when there can be (or may not be) SSB-to-RO mapping separation between the additional ROs and first ROs. There may be different SSB-to-RO mapping when additional ROs are non-overlapped in time and frequency with first ROs. There may be a same SSB-to-RO mapping when additional ROs are overlapped in time and/or frequency with first ROs. If a PDCCH order indicates a particular RO, and additional ROs are active in addition to first ROs, it may be unclear how to determine which ROs are indicated by the PRACH mask index and an SSB index. A related technical challenge is how to support a faster response to a PDCCH order.

Aspects of the present disclosure relate generally to techniques for supporting dynamic adaptation of PRACH in the time domain. Some technical aspects more specifically relate to indicating or selecting which ROs a PRACH mask index corresponds to when there may be one or both first ROs or additional ROs. That is, the techniques may provide enhancements to SSB-to-RO mapping and resolution of ambiguity of indication of an RO for a PDCCH order when additional ROs are activated. Furthermore, some aspects provide technical solutions that provide the advantage of a faster response to a PDCCH order in instances where additional ROs are activated. That is, techniques described herein can enable apparatuses, such as a user equipment and a network entity, to communicate on earliest available and user equipment compatible ROs thereby enhancing energy saving opportunities and improving the speed in which a response to a PDCCH order and/or subsequent processes such as Random Access procedure is able to occur. The various technical solutions are described in detail herein.

In certain aspects, the PRACH mask index may indicate the ROs associated with the SSB indicated by the SSB index for PRACH resources in accordance with an association rule. An association rule is a rule that indicates a subset of ROs from which to select an RO for PRACH transmission when both first ROs and additional ROs are activated. For example, the association rule may indicate that the subset of ROs comprises first ROs (that is, for semi-statically configured ROs or ROs usable by first user equipments that may only be capable of communication on the first ROs and not capable of communications on additional ROs). In certain aspects, the association rule may indicate that the subset of ROs comprises additional ROs. For example, in this case, the PRACH mask index indicates the ROs associated with the SSB indicated by the SSB index of the PDCCH order for the additional ROs (when the additional ROs are activated). In certain aspects, the association rule indicates that the subset of ROs are selected from the one or more first ROs or the one or more additional ROs based on which set of ROs, of the one or more first ROs or the one or more additional ROs, has an RO occurring earliest after the PDCCH order. In this case, the PRACH mask index may indicate the ROs that occur at the earliest time following the PDCCH order configured to specify the PRACH mask index. In certain aspects, the association rule indicates that the subset of ROs comprises one or more ROs occurring earliest after the PDCCH order and corresponding to the SSB index, where the one or more ROs are one of: the one or more first ROs or the one or more additional ROs. For example, the PRACH mask index may indicate the RO(s) associated with the SSB indicated by the SSB index and which occur at the earliest time following the PDCCH order configured to specify the PRACH mask index. In certain aspects, the user equipment may be configured to overwrite an existing SSB-to-RO mapping to the SSB index indicated by the PDCCH order. Each of these solutions and further aspects and technical advantages related thereto will be described in detail herein.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

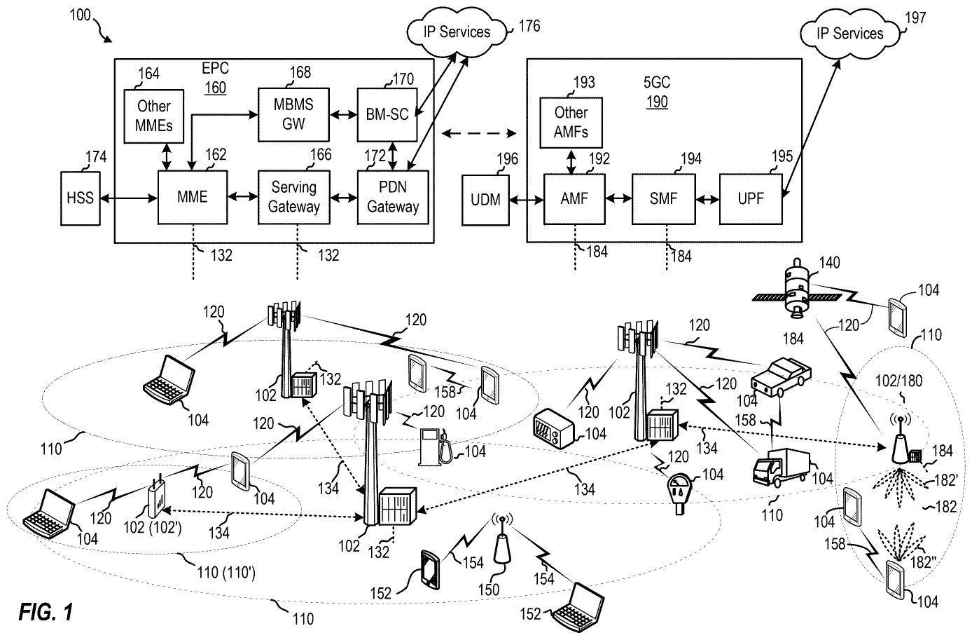

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

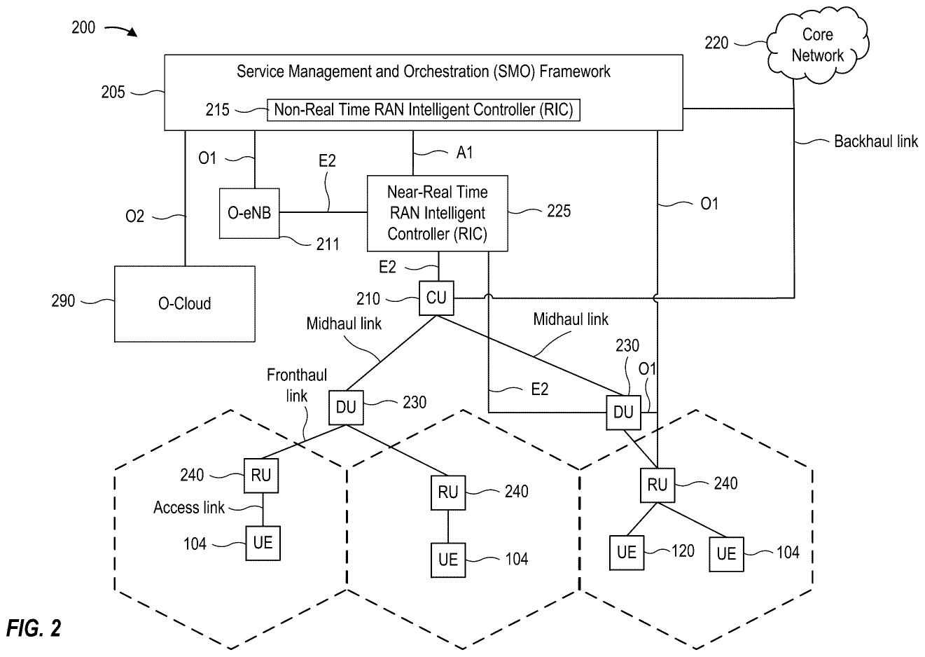

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHZ, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QOS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

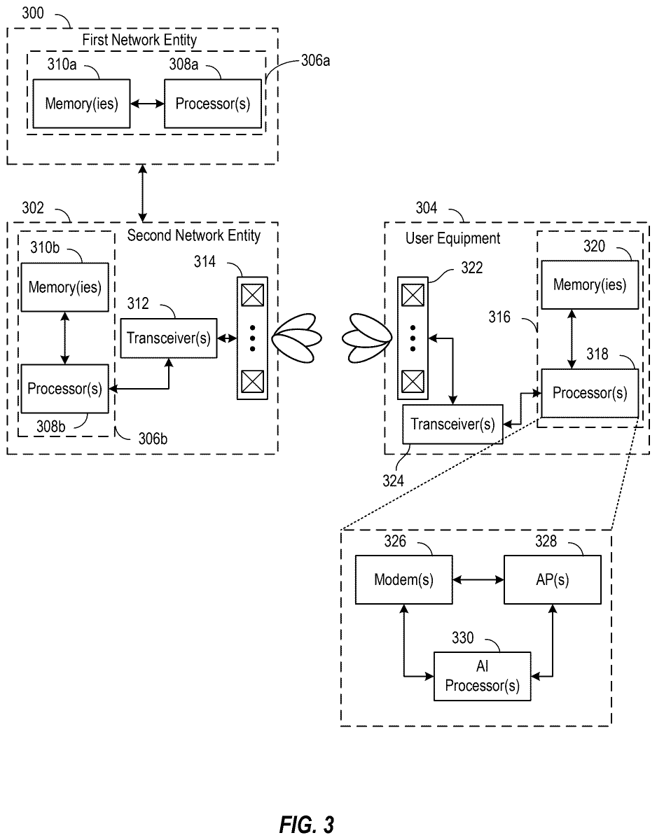

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

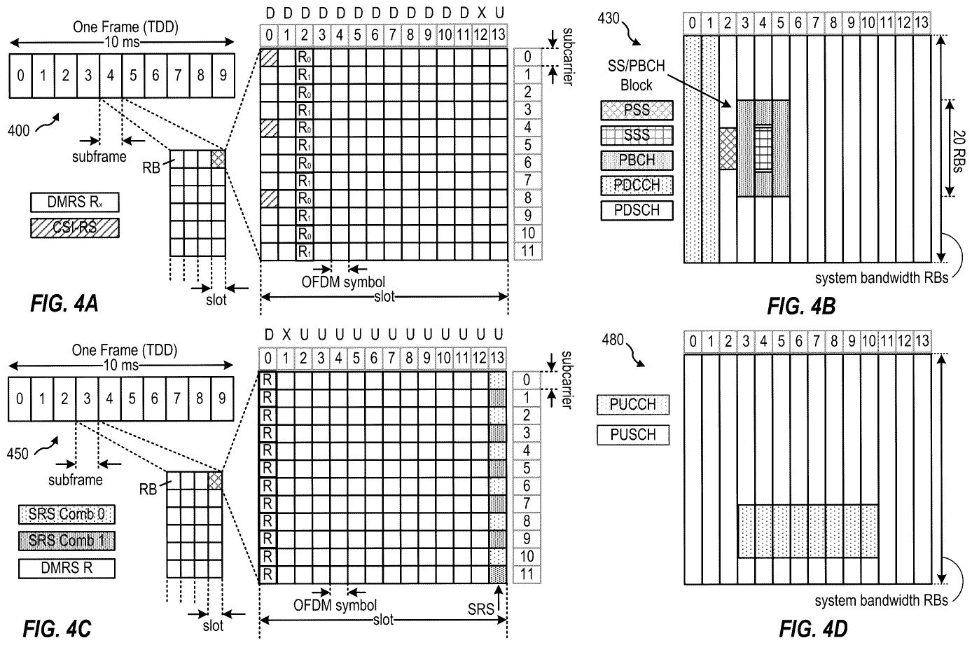

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (u) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

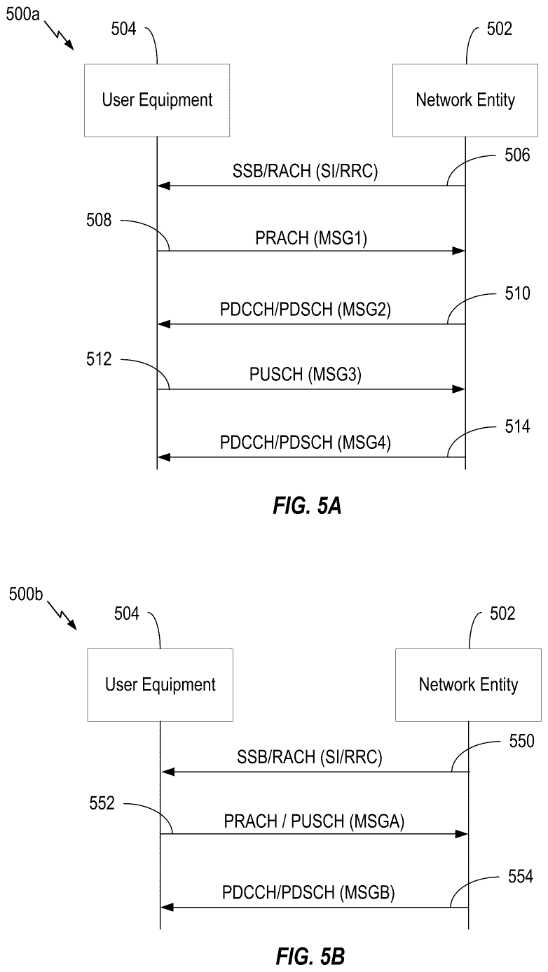

FIG. 5A depicts a process flow diagram of an example four-step RACH procedure 500a performed between a UE 504 and a network entity 502. In some aspects, the UE 504 is the UE 104 depicted and described with respect to FIG. 1 or the UE 304 depicted and described with respect to FIG. 3. In some aspects, the network entity 502 is the BS 102 depicted and described with respect to FIG. 1, the network entity 300 or 302 depicted and described with respect to FIG. 3, or a disaggregated base station depicted and described with respect to FIG. 2.

The RACH procedure 500a may optionally begin at 506, where the network entity 502 broadcasts and the UE 504 receives a random access configuration. The random access configuration may be referred to herein as a PRACH configuration. The network entity 502 may broadcast the random access configuration, for example, in system information (SI) via an SSB, or via an RRC message. The random access configuration may indicate or include one or more parameters for random access communications, such as defining the RACH, the total number of random access preambles (for example, preamble sequences) available for random access, power ramping parameters, and/or a response window size.

At 508, the UE 504 sends a first message (MSG1) to the network entity 502 on a PRACH. In some cases, a PRACH may be referred to as a RACH. In certain aspects, MSG1 may indicate or include a RACH preamble. The RACH preamble may be or include a preamble sequence (for example, a Zadoff Chu sequence). For contention-based random access, the preamble sequence may be randomly selected among a set of preamble sequences (for example, up to 64 sequences, in some cases). The preamble sequence may be used to identify the UE 504 for scheduling communications (for example, MSG2 and MSG3) with the network entity. In certain aspects, terms such as “RACH preamble,” “random access preamble,” “preamble,” “preamble sequence,” “sequence,” and the like may be used interchangeably.

At 510, the network entity 502 may respond with a random access response (RAR) message (MSG2). For example, the network entity 502 may send a PDCCH communication including downlink control information (DCI) that schedules the RAR on the PDSCH. The RAR may include, for example, certain parameters used for an uplink transmission such as a random access (RA) preamble identifier (RAPID), a timing advance, an uplink (UL) grant (for example, indicating one or more time-frequency resources for an uplink transmission), temporary cell radio network temporary identifier (TC-RNTI), and/or a backoff parameter value. The RAPID may correspond to the preamble sequence and indicate that the RAR is for the UE 504 that transmitted MSG1 at 506. The backoff parameter value may be used to determine a RO for sending a subsequent RACH transmission (for example, a preamble transmission). An RO may correspond to one or more time-frequency resources available for transmitting a preamble in a RACH.

At 512, in response to MSG2, the UE 504 transmits a third message (MSG3) to the network entity 502 on the PUSCH. In some aspects, MSG3 may include an RRC connection request, a tracking area update (for UE mobility), and/or a scheduling request (for an UL transmission). As an example, MSG3 is communicated in the time-frequency resource(s) indicated in the UL grant of the RAR.

At 514, the network entity 502 may send a contention resolution message (MSG4) in response to MSG3. The network entity 502 may send a downlink scheduling command (for example, DCI), which is addressed to a specific UE identity associated with the UE 504, via the PDCCH. The network entity 502 may send a UE contention resolution identity (for example, in a medium access control element) via the PDSCH according to the downlink scheduling command. In certain cases, multiple UEs may send the same preamble in the same RO. Because the network entity 502 may not be able to identify which UE sent which preamble, the network entity 502 may reply with a single RAR associated with the preamble. The MSG3 may include or indicate a specific UE identity associated with the UE 504, such as a radio network temporary identifier (RNTI) or a temporary mobile subscriber identity (TMSI). The network entity 502 may decode MSG3 and determine the UE identity associated with at least one of the UEs (for example, UE 504). MSG4 may be addressed to the UE identity (for example the RNTI or an RNTI based on the TMSI) associated with the MSG3 that the network entity was able to successfully decode. For example, the MSG4 may be scrambled by the RNTI associated with the MSG3. If the UE 504 obtains the same identity sent in MSG3, the UE 504 concludes that the random access procedure succeeded. In some cases, if the UE 504 is unable to obtain or decode MSG3 and/or MSG4, the UE 504 may repeat the RACH procedure, such as the four-step RACH procedure 500a.

In some cases, to reduce the latency associated with random access, a two-step RACH procedure may be used. The two-step RACH procedure may effectively consolidate the four messages of the four-step RACH procedure into two messages.

FIG. 5B depicts a process flow diagram of an example two-step RACH procedure 500b performed between the UE 504 and the network entity 502.

The procedure 500b may optionally begin at 550, where the network entity 502 broadcasts and the UE 504 receives a random access configuration, for example in system information within an SSB, or in an RRC message.

At 552, the UE 504 sends a first message (MSGA) to the network entity 502, which may effectively combine MSG1 and MSG3 described above with respect to FIG. 5A. In some aspects, MSGA includes a RACH preamble for random access and a payload. For example, the payload may include a UE-ID and other signaling information, such as a buffer status report or scheduling request. The RACH preamble of MSGA may be transmitted over the PRACH, and the payload of MSGA may be transmitted over the PUSCH, for example.

At 554, the network entity 502 may send a random access response message (MSGB), which may effectively combine MSG2 and MSG4 described above, via the PDCCH and PDSCH. For example, MSGB may include a RAPID, a timing advance, a backoff parameter value, a contention resolution message, an uplink and/or downlink grant, and a transmit power control command.

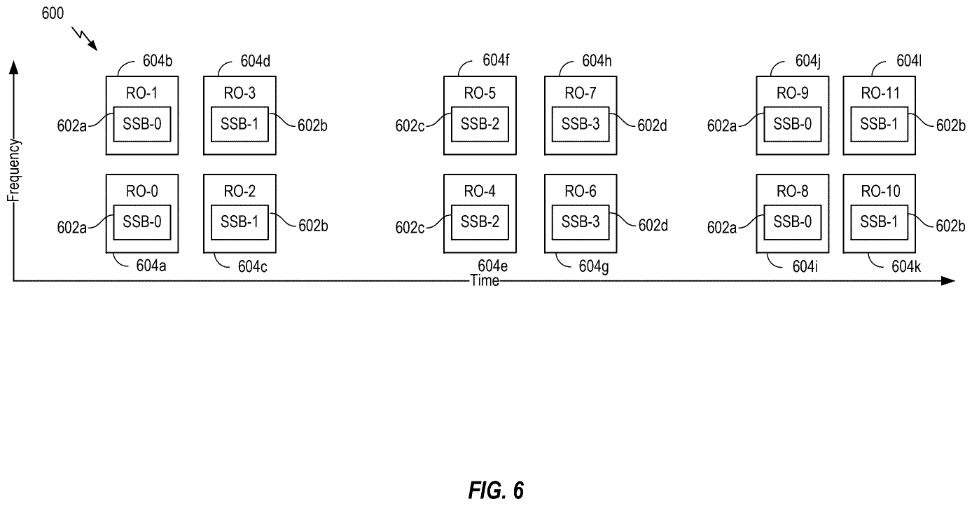

FIG. 6 illustrates an example mapping 600 of SSBs to ROs. The example mapping 600 may be performed based on a set of parameters. In certain aspects, the set of parameters may indicate an SSB to RO mapping (sometimes referred to as an SSB-to-RO mapping or an SSB mapping). For example, the set of parameters may include or indicate a random access configuration index (for example, prach-ConfigurationIndex) that indicates a specific row of parameters in one or more look-up tables of multiple SSB to RO mappings, where each row of parameters may indicate a different SSB to RO mapping.

In mapping 600, there are a total of four SSBs 602a-d communicated by a network entity, and the FDM number is set to two, which allocates two FDM ROs in a time instance of a single RO. The second set of parameters are configured to allow certain ROs associated with the second set of parameters to overlap in time and frequency resources with a subset of the ROs associated with the first set of parameters.

The mapping 600 has a total of twelve ROs 604a-1. The mapping 600 maps the first SSB 602a to the first RO 604a and the second RO 604b. The second SSB 602b is mapped to the third RO 604c and the fourth RO 604d, and so on for the subsequent SSBs 602c, 602d and the ROs 604e-1.

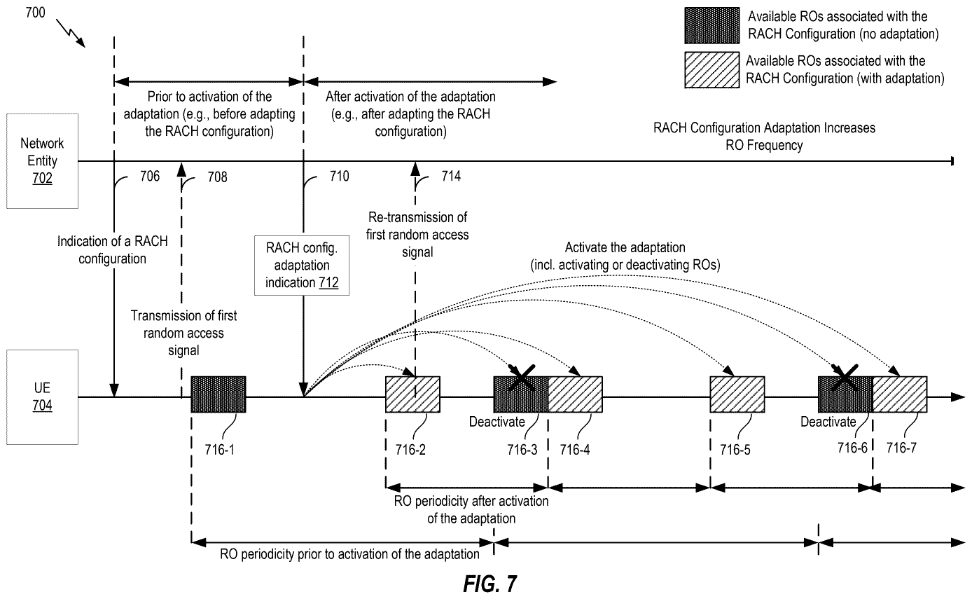

FIG. 7 depicts a process flow 700 for communications in a network between a network entity 702 and a UE 704. In certain aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. However, in other aspects, UE 704 may be another type of wireless communications device and network entity 702 may be another type of network entity or network node, such as those described herein. Note that any operations or signaling illustrated with dashed lines may indicate that that operation or signaling is an optional or alternative example.

Signaling in process flow 700 of FIG. 7 may be performed to adapt a RACH configuration identifying ROs corresponding to time-frequency resources configured for random access communications. In certain aspects, as shown in process flow 700, the RACH configuration may be adapted such as to activate new ROs and deactivate ROs associated with an original RACH configuration. In process flow 700 of FIG. 7, the RACH configuration adaptation may occur to increase a frequency of ROs configured for random access communications, such as for communicating a subsequent random access signal after a RACH procedure has been initiated. Alternatively, the RACH configuration adaptation may occur to reduce a frequency of ROs configured for random access communications, such as for communicating the subsequent random access signal after a RACH procedure has been initiated. In some aspects, an RO may be referred to as or included in a PRACH resource.

At 706, network entity 702 sends, to UE 704, an indication of a RACH configuration. The RACH configuration may identify three ROs (e.g., RO 716-1, RO 716-3, and RO 716-6) corresponding to time-frequency resources configured for random access communications. For example, the RACH configuration may be associated with RO 716-1, RO 716-3, and RO 716-6, which have a first RO periodicity (e.g., shown as the “RO periodicity prior to activation of the adaptation” in FIG. 7). UE 704 may use RO 716-1, RO 716-3, and/or RO 716-6 for sending a random access signal to initiate a RACH procedure with network entity 702.

At 708, UE 704 determines to initiate a first RACH procedure with network entity 702 and sends, to network entity 702, a first random access signal. Note that PRACH adaptation can be implemented without the UE 704 first sending a first random access signal. In certain aspects, the first random access signal is a first message (MSG1) sent on a PRACH during a four-step RACH procedure, such as the first message (MSG1) sent at 510 in RACH procedure 500a of FIG. 5A. In certain aspects, the first random access signal is a first message (MSGA) sent on a PRACH during a two-step RACH procedure, such as the first message (MSGA) sent at 554 in RACH procedure 500b of FIG. 5B. In this example, UE 704 sends, to network entity 702, the first random access in RO 716-1, which is an RO associated with the RACH configuration (e.g., received at 706).

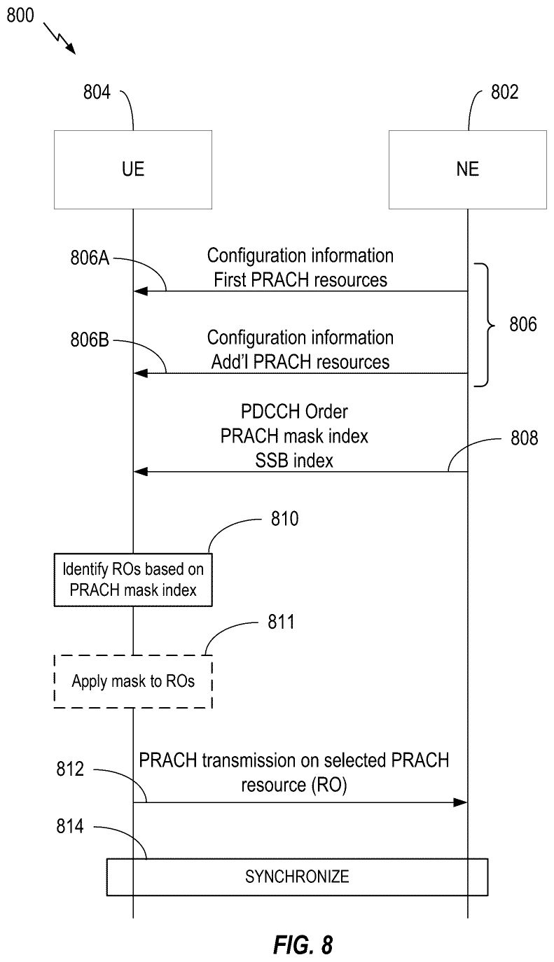

At 710, network entity 702 sends, a RACH configuration adaptation indication 712. In certain aspects, the RACH configuration adaptation indication 712, communicated at 710 may be included in a PEI. In certain other aspects, the RACH configuration adaptation indication 712 may be included in a paging DCI message. This is described in more detail in connection with FIG. 8.

The RACH configuration adaptation indication 712 may be an indication of an activation of an adaptation associated with one or more RO(s). For this example, the RACH configuration adaptation indication 712 may be an indication of an activation of an adaptation associated with six ROs, e.g., RO 716-2, RO 716-3, RO 716-4, RO 716-5, RO 716-6, and RO 716-7. Two of the ROs associated with the adaptation (e.g., indicated to be activated by the RACH configuration adaptation indication 712), such as RO 716-3 and RO 716-6, are also associated with the RACH configuration (e.g., the original RACH configuration indicated to UE 704 at 706). In this example, the adaptation may (1) activate RO 716-2, RO 716-4, RO 716-5, and 716-7, and also (2) deactivate RO 716-3 and RO 716-6 (as shown in FIG. 7). Thus, when the adaptation is activated (and where the RACH configuration adaptation indication 712 indicates such activation), RO 716-2, RO 716-4, RO 716-5, and RO 716-7 may be activated (e.g., added to the RACH configuration for subsequent random access communications. Further, when the adaptation is activated (and where the RACH configuration adaptation indication 712 indicates such activation), RO 716-3 and RO 716-6 may be deactivated (e.g., muted in the RACH configuration, where they are unable to be used for subsequent random access communications. Put differently, in this example, the original RACH configuration (e.g., indicated to UE 704 at 706), associated with RO 716-1, RO 716-3, and RO 716-6, may be replaced by a new RACH configuration (e.g., the adapted RACH configuration), associated with RO 716-2, RO 716-4, RO 716-5, and RO 716-7. ROs of the new RACH configuration may have a second RO periodicity (e.g., shown as the RO periodicity after to activation of the adaptation in FIG. 7). The second RO periodicity may be less than the first RO periodicity associated with the original RACH configuration, such that the RACH configuration adaptation indication 712 increases the RO frequency.

This increase in RO frequency may enable the UE to send a re-transmission of the first random access signal or a second random access signal to initiate a second RACH procedure more frequently with the adapted (e.g., new) RACH configuration than with the original RACH configuration. For example, UE 704 may send, to network entity 702 at 714, a re-transmission of the first random access signal using an RO associated with the adapted RACH configuration. Specifically, in the example shown in FIG. 7, UE 704 may use RO 716-2, associated with the adapted (e.g., new) RACH configuration to send a re-transmission of the first random access signal. Alternatively, in certain aspects, UE 704 may send, to network entity 702 at 714, a second random access signal to initiate a second RACH procedure using one of the RO(s) associated with the adapted (e.g., new) RACH configuration (not shown in FIG. 7).

While in FIG. 7, the activation of the adaptation (e.g., based on network entity 702 sending, at 710, the RACH configuration adaptation indication 712 of activation of the adaptation) results in an increase in the RO frequency, in some other examples, an activation of an adaptation may result in a reduction in the RO frequency (e.g., reduction in the frequency of ROs that UE 704 may use during a period of time for sending a random access signal).

Although FIG. 7 depicts the example use of a RACH configuration adaptation indication to change RO periodicity, in some other examples, a RACH configuration adaptation indication may be used to more generally cause any change to the configured ROs, such as including adding (e.g., activating) one or more ROs and/or muting one or more ROs (e.g., deactivating). In some examples, the adaptation affects the additional ROs by activation or deactivation of one or more of the additional ROs, without changing the first ROs configured, for example, initially via RRC signaling.

FIG. 8 is a diagram illustrating an example 800 of signaling, interpretation of ROs and indications of dynamic adaptations of PRACH. Example 800 includes a network entity 802 and a UE 804. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

In some aspects, the network entity 802 may transmit, and the UE 804 may receive, configuration information 806A and/or 806B (generally referred to as configuration information 806). In some aspects, the configuration information 806 may be the configuration information 806A that may indicate a set of first PRACH resources (e.g., one or more first ROs) and/or information associated with activating the set of first PRACH resources. In some aspects, the configuration information 806B may indicate a set of additional PRACH resources (e.g., one or more additional ROs) and information associated with activating the set of additional PRACH resources. For example, the configuration information 806 may be the configuration information 806B that may indicate a first set of additional PRACH resources and corresponding value. The corresponding value, if received in an availability indication, may indicate for and/or cause the UE 804 to activate the corresponding first set of additional PRACH resources. The configuration information 806B may also indicate a second set of additional PRACH resources and a second corresponding value, and so on.

In some aspects, the configuration information 806A and/or 806B may indicate a timeline associated with an availability indication. For example, a timeline may include information indicating a beginning of an activation of a PRACH resource (e.g., a time, after reception of an availability indication, at which the PRACH resource is available for transmission or indication of activation), a length of the activation (e.g., a length of time for which the PRACH resource is available for transmission or indication of activation), whether the PRACH resource has to be explicitly deactivated, whether the activated PRACH resources reoccur periodically in time, or the like.

The network entity 802 may transmit, and the UE 804 may receive, a PDCCH order 808. In some aspects, the network entity 802 may transmit, and the UE 804 may receive more than one PDCCH order 808. The PDCCH order includes a PRACH mask index and a SSB index. The PDCCH order initiates a random access procedure of an RRC-connected-mode UE. The PDCCH order is transmitted using DCI format 1_0 with the frequency-domain allocation field bits set to 1 and CRC bits scrambled using C-RNTI.

Fields of the DCI related to PDCCH order include: C, which indicates the presence of the contention-free random access resources fields; S/U, which indicates which UL carrier to transmit the PRACH; a repetition number, which indicates the Msg1 repetition number to be applied to the contention-free Random Access, a random access preamble index, which may be a 6 bits field indicating the random access preamble index; a SSB index, which specifies the SSB index to be used to determine the RO; and one or more PRACH mask indexes, which indicate the ROs associated with the SSB indicated by the SSB index for the PRACH transmission of the contention-free random access resources. The SSB index indicates a subset of ROs from either rach-ConfigDedicated or rach-ConfigCommon. The PRACH mask index field may be 4 bits. Table 1, provided above, illustrates the ROs available for each PRACH mask index value.

In some aspects, the first set of additional PRACH resources (e.g., the additional ROs) may be different than a second set of additional PRACH resources. For example, there may be at least one PRACH resource that is included in only of the first set of additional PRACH resources and the second set of additional PRACH resources. While in FIG. 8, the first availability indication and the second availability indicate additional PRACH resources, in some aspects, the first availability indication and/or the second availability indication may modify a set of PRACH resources, such as by changing available PRACH resources or deactivating certain PRACH resources.

At block 810, the UE 804 may identify the ROs corresponding to the PDCCH order based at least on the PRACH mask index and/or the SSB index. Identification of the RO (e.g., selection of the RO) may be accomplished according to one or more association rules, which will be described in more detail here. At block 811, the UE 804 may optionally apply the PRACH mask to the ROs for PRACH transmissions, or application of the PRACH mask may be included in block 810.

The UE 804 may perform a PRACH transmission 812 on a selected PRACH resource as determined through blocks 810 and/or 811. The PRACH transmission 812 may include a RACH preamble, a MSG1, at least part of a MSGA, or the like. In some aspects, the network entity 802 and the UE 804 may proceed with a synchronization process, such as a random access procedure of an RRC-connected-mode UE.

### Aspects Related to Dynamic Adaptation of PRACH in Time Domain

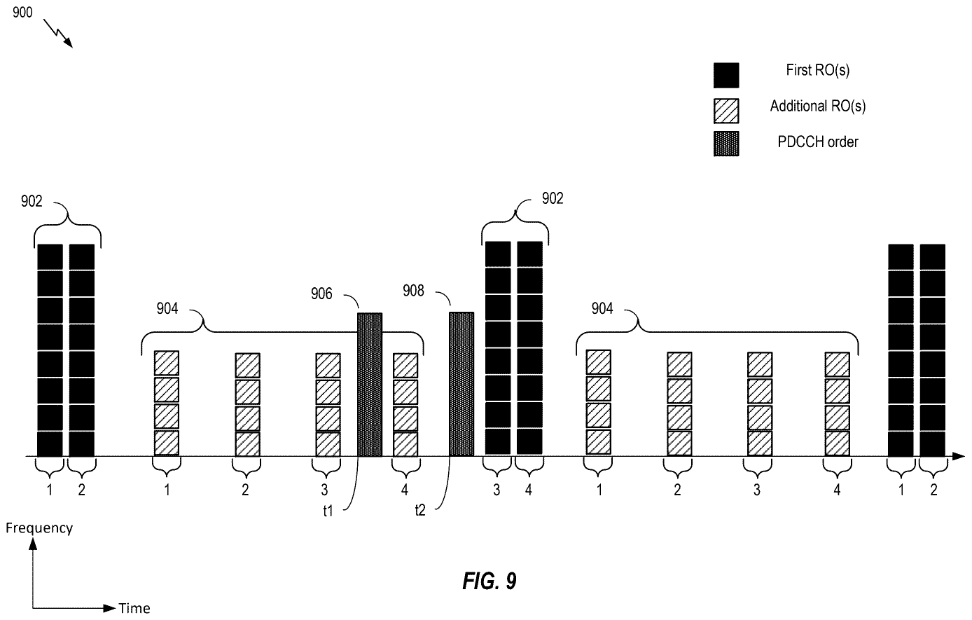

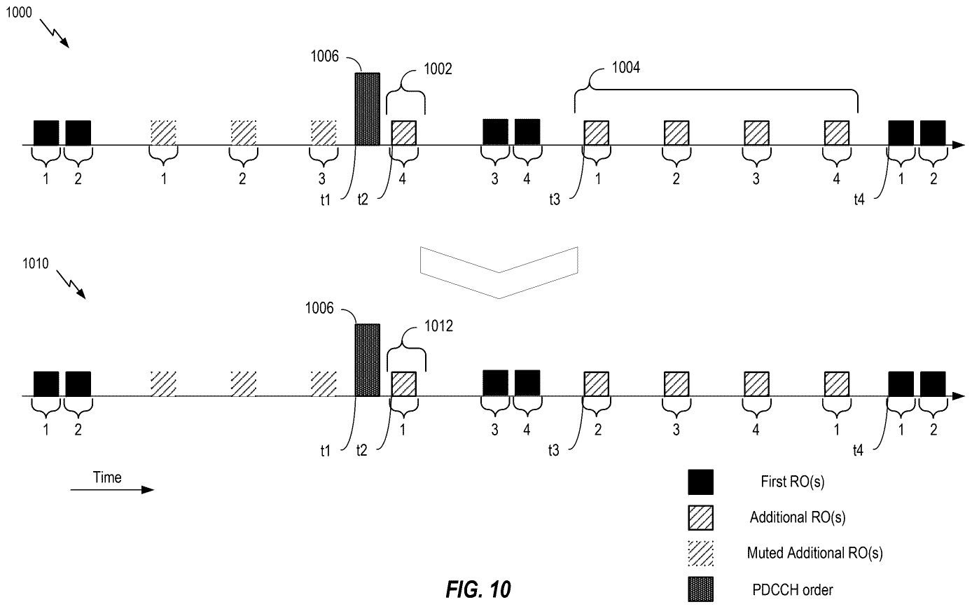

FIGS. 9 and 10 depict illustrative example ROs specified in the time domain and the frequency domain. It is noted that ROs are specified in time and frequency domain, but the examples discussed herein are directed to adaptations of PRACH in the time domain. However, the examples discussed herein are not limited to adaptations in the time domain and are equally applicable to adaptation in the frequency domain, the preamble domain, the spatial domain, or the like. The examples depicted in FIGS. 9 and 10 are used to describe the various association rules that address the how to handle a PRACH mask index (or multiple PRACH mask indexes) in a PDCCH order when there is or is not SSB-to-RO mapping separation between the additional ROs and first ROs. The association rules and the various implementations described herein provide technical advantages, such as supporting faster responses to a PDCCH order and eliminating ambiguity in which ROs are available for random access in response to a PDCCH order in the context of dynamic RACH adaptation.

FIG. 9 depicts an example 900 of mapping between SSB and ROs which include both one or more first ROs 902 and one or more additional ROs 904. Example 900 depicts a plurality of scheduled ROs in the time domain. Example 900 depicts subsets of ROs, depicted by the illustrated blocks (e.g., one or more first ROs 902 and one or more additional ROs 904), mapped to corresponding SSBs indicated by index numerals 1, 2, 3, 4. The one or more first ROs 902 may have long periodicity to save energy. The one or more additional ROs 904 can be activated/deactivated in a fast and dynamic manner.

For example, the one or more first ROs 902 may include one or more frequency ROs. In particular, the one or more first ROs 902 include 8 frequency ROs at the same time. The ROs at the same time correspond to a given SSB index, however, this is merely one example. Furthermore, for example, the one or more additional ROs 904 may include one or more frequency ROs. In particular, the one or more additional ROs 904 include 4 frequency ROs at the same time. The ROs at the same time correspond to a given SSB index, however, this is merely one example. Indication as to which of the one or more frequency ROs that a UE may utilize may be indicated by the PRACH mask index, for example, as depicted in Table 1, based on one or more association rules.

Example 900 relates to four (4) SSBs and the SSB index (e.g., index numerals 1, 2, 3, 4) of the SSB corresponding to (e.g., mapped to) each RO at the same time is indicated below each RO box. It should be understood that example 900 is only one example SSB-to-RO mapping in the time domain.

Example 900 also depicts a PDCCH order 906 occurring at time t1 and a second PDCCH order 908 occurring at time t2. The PDCCH order 906 and the second PDCCH order 908 may be transmitted by the network entity 802 of FIG. 8 to UE 804 of FIG. 8. In some aspects, the network entity 802 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 804 may be an example of UE 104 depicted and described with respect to FIG. 1 or the UE 304 depicted and described with respect to FIG. 3. However, in other aspects, UE 804 may be another type of wireless communications device and network entity 802 may be another type of network entity or network node, such as those described herein.

In some aspects, the PDCCH order 906 specifies a single PRACH mask index. In such instances, one or more association rules for the PDCCH order 906 may indicate the ROs to be associated with the PRACH mask index and/or the SSB indicated by the SSB index indicated by the PDCCH order 906. An RO may be associated with a PRACH mask index if the RO can be indicated by the PRACH mask index as available for a random access procedure in response to the PDCCH order 906. In certain aspects, the PRACH mask index may be configured in the network entity 802 and/or the UE 804 to indicate a subset of ROs that includes the one or more first ROs 902. For example, the PRACH mask index may indicate, primarily, the ROs associated with the SSB indicated by the SSB index for PRACH resources for legacy UEs. In certain aspects, the PRACH mask index may be configured in the network entity 802 and/or the UE 804 to indicate a subset of ROs that includes the one or more additional ROs 904, in instances where one or more additional ROs 904 are activated. For example, the PRACH mask index may indicate, primarily, the ROs associated with the SSB indicated by the SSB index for additional PRACH resources, in case the additional PRACH resources are activated.

In certain aspects, the PRACH mask index may be configured in the network entity 802 and/or the UE 804 to indicate that the subset of ROs are selected from the one or more first ROs 902 or the one or more additional ROs 904 based on which set of ROs, of the one or more first ROs 902 or the one or more additional ROs 904, has an RO occurring earliest after the PDCCH order 906. For example, as depicted in example 900, the RO occurring earliest after the PDCCH order 906 is an additional RO of the one or more additional ROs 904. In this aspect, the SSB index may not limit the RO that is indicated. That is, the RO occurring earliest after the PDCCH order 906 may not correspond to the SSB index indicated by the PDCCH order. For example, PDCCH order 906 may have a SSB index of 3, but the RO occurring earliest after the PDCCH order 906 may be indicated by a SSB index of 4, however, this RO is associated with the PRACH mask index indicated by the PDCCH order 906. Thus, the PRACH mask index may indicate, primarily, the ROs associated with the SSB indicated by the SSB index for ROs scheduled first (that is the earliest) after the transmission of the PDCCH order 906.

Contrary to the aforementioned association rule that may not take into account the SSB index when select the RO for transmitting the PRACH preamble, the next association rule selects an RO that occurs earliest after the PDCCH order 906 and is in accordance with the SSB index of the PDCCH order 906. In such aspects, the PRACH mask index may be configured in the network entity 802 and/or the UE 804 to indicate that the subset of ROs, from which the RO for transmitting the PRACH preamble is selected, comprises an RO occurring earliest after the PDCCH order 906 and corresponding to the SSB index. In these aspects, the RO may be one of the one or more first ROs 902 or the one or more additional ROs 904. For example, if the PDCCH order 906 includes an SSB index of 4, the PRACH mask index would correspond to one of the one or more additional ROs 904 occurring after time t1, since the one or more additional ROs 904 mapped to an SSB index of 4 occur earliest after time t1. As another example, if the PDCCH order 906 includes an SSB index of 3, the PRACH mask index would correspond to one of the one or more first ROs 902 occurring after time t1 since the one or more first ROs 902 mapped to an SSB index of 3 occur earliest after time t1. By way of another example, if the PDCCH order 906 includes an SSB index of 1, the PRACH mask index would correspond to one of the one or more additional ROs 904 occurring after time t1 since the one or more additional ROs 904 mapped to an SSB index of 1 occur earliest after time t1. Thus, the PRACH mask index may indicate, primarily, the ROs associated with the SSB indicated by the SSB index for ROs which have the earliest occurrence of an RO corresponding to the indicated SSB index.

The aforementioned association rules are directed to linking the PRACH mask index received in the PDCCH order 906 with either the one or more first ROs 902 or the one or more additional ROs 904 in the case that the one or more additional ROs 904 are activated. In some aspects, for example, when the PRACH mask index is linked to one set of ROs, of the one or more first ROs 902 or one or more additional ROs 904, the other set of ROs, of the one of the one or more first ROs 902 or one or more additional ROs 904, need to be linked to a PRACH mask index. For example, if the PRACH mask index corresponds to the PRACH resources for the one or more first ROs 902, then a PRACH mask index for the one or more additional ROs 904, when activated, needs to be indicated or indicatable. The aforementioned is a technical challenge because it may not always be possible to use the same PRACH mask index for both set of ROs. For example, this may be the case when there are separate SSB-to-RO mappings and/or when the PRACH mask that is indicated in the PDCCH order is not physically possible to implement for the other set of ROs. For instance, if the PRACH mask index equals 8, according to Table 1, the RO index the UE 804 may use to transmit is index 8. In example 900, the aforementioned PRACH mask index is physically possible to implement for the one or more first ROs 902 since there are 8 possible frequency ROs defined per SSB (e.g. eight vertical blocks for each of the additional ROs 904). However, the aforementioned PRACH mask index is not physically possible to implement for the one or more additional ROs 904 since there are only 4 possible frequency ROs defined per SSB (e.g. four vertical blocks for each of the additional ROs 904). Following example 900 further, PRACH mask indexes 5-8 would not be physically possible to implement for the one or more additional ROs 904.

There may be different solutions implemented to the aforementioned challenge. In certain aspects, when the same set of SSB indexes (e.g., SSB index 1, 2, 3, 4) are mapped to both the one or more first ROs 902 and the one or more additional ROs 904, and the same SSB-RO mapping is used in both the one or more first ROs 902 and the one or more additional ROs 904, the PRACH mask index can be applied to both the one or more first ROs 902 and the one or more additional ROs 904. For example, in some instances the exact same set of SSB indexes are mapped to both the one or more first ROs 902 and the one or more additional ROs 904. For example, a PDCCH order may include an SSB index of 3 and a PRACH mask index of 1. In this example, an RO will be selected from the subset of ROs mapped to SSB 3 and an RO with an index of 1 (for example, where the subset of ROs is determined according to the association rule described above). As such, the PRACH mask index may be applied to both the one or more first ROs 902 and the one or more additional ROs 904 irrespective of which of these is selected as the subset of ROs. Thus, if the same set of SSB indexes are mapped to both first ROs and additional ROs, the same PRACH mask index can be applied to both of these sets of ROs.

In some aspects, when the same set of SSB indexes (e.g., SSB index 1, 2, 3, 4) are mapped to both the one or more first ROs 902 and the one or more additional ROs 904, the PRACH mask index may be applied to the one or more first ROs 902 and a second PRACH mask index that is predefined (for example, stored in a memory of the UE 804, specified in a wireless communication specification, or the like) may be applied to the one or more additional ROs 904. For example, the second PRACH mask index may be defined as having an index of 0 (e.g., indicating all ROs according to Table 1) or an index of 1 (e.g., indicating the first RO according to Table 1). In some aspects, when the same (e.g., exact same) set of SSB indexes (e.g., SSB index 1, 2, 3, 4) are mapped to both the one or more first ROs 902 and the one or more additional ROs 904, the PRACH mask index may be applied to the one or more additional ROs 904 and a second PRACH mask index that is predefined (for example, stored in a memory of the UE 804, specified in a wireless communication specification, or the like), may be used for the one or more first ROs 902. For example, the second PRACH mask index may be defined as having an index of 0 (e.g., indicating all ROs) or an index of 1 (e.g., indicating the first RO). For example, if the same set of SSB indexes are mapped to both the first ROs and the additional ROs, a PRACH mask index to be used may be fixed for the “secondary ROs” (that is, ROs to which an indicated PRACH mask index of the PDCCH order 906 does not primarily apply), and thus may always be the same.

In other aspects, different sets of SSB indexes may be mapped to respective ROs (e.g., the one or more first ROs 902 and the one or more additional ROs 904). For example, a first set of SSB indexes (e.g., indexes 1, 2, 3, 4) may be mapped to the one or more first ROs 902 and a second set of SSB indexes (e.g., indexes 1, 2) may be mapped to the one or more additional ROs 904. In the aforementioned example, for the one or more additional ROs 904, SSB indexes 1 and 2 may be activated, since many UEs may use those SSB indexes, but no additional ROs with SSB indexes of 3 and 4 may be activated. In instances where the PRACH mask index in the PDCCH order is physically possible to implement for ROs of the one or more first ROs 902 and the one or more additional ROs 904 associated with the SSB index, the PRACH mask index can be applied to both the one or more first ROs 902 and the one or more additional ROs 904. However, in instances where the PRACH mask index in the PDCCH order is not physically possible to implement for ROs of the one or more first ROs 902 and the one or more additional ROs 904, a predefined PRACH mask index (for example, an index stored in a memory of the UE 804, specified in a wireless communication specification, or the like) may be applied to both the one or more first ROs 902 and the one or more additional ROs 904 or only the ROs that cannot physically implement the PRACH mask index. For instance, if the PRACH mask index equals 8, according to Table 1, the RO index that the UE may use to transmit is index 8. In example 900, the aforementioned PRACH mask index having an index equal to 8 is physically possible to implement for the one or more first ROs 902 since there are 8 possible frequency ROs defined (e.g. eight vertical blocks for each of the additional ROs 904). However, the aforementioned PRACH mask index having an index equal to 8 is not physically possible to implement for the one or more additional ROs 904 since there are only 4 possible frequency ROs defined (e.g. four vertical blocks for each of the additional ROs 904). Following example 900 further, PRACH mask indexes 5-8 would not be physically possible to implement for the one or more additional ROs 904. For the instances where the PRACH mask index is not possible to implement because an RO corresponding to the one or more ROs indicated for use by the PRACH mask index is not defined, the UE 804 may use a PRACH mask index that is predefined (for example, stored in a memory of the UE 804, specified in a wireless communication specification, or the like). For example, a predefined PRACH mask index may be defined as having an index of 0 (e.g., indicating all ROs) or an index of 1 (e.g., indicating the first RO).

Continuing with aspects where different sets of SSB indexes (e.g., a first set of SSB indexes 1, 2, 3, 4) may be mapped to the one or more first ROs 902 and a second set of SSB indexes (e.g., a first set of SSB indexes 1, 2) may be mapped to the one or more additional ROs, the UE 804 may be configured to utilize a second PRACH mask index that is predefined (for example, stored in a memory of the UE 804, specified in a wireless communication specification, or the like). More specifically, if separate SSB to RO mappings are used, the UE 804 and network entity 802 may always use a predefined and fixed set of RO(s) (e.g., a predefined PRACH mask index). For example, the predefined PRACH mask index may be defined as having an index of 0 (e.g., indicating all ROs) or an index of 1 (e.g., indicating the first RO).

The previously discussed association rules and corresponding configurations provide solutions where only one PRACH mask index is utilized. Some additional solutions, described below, may include explicitly configuring respective PRACH mask indexes for the one or more first ROs 902 and the one or more additional ROs 904.

In certain aspects, where separate SSB-to-RO mappings are used in cases of dynamic adaptation of ROs in the time domain, an optional second PRACH mask index field can be added to DCI format 1_0. For example, the PDCCH order 906 may include a plurality of PRACH mask indexes including the PRACH mask index and a second PRACH mask index. The PRACH mask index may correspond to the one or more first ROs 902 associated with the SSB index and the second PRACH mask index may correspond to the one or more additional ROs 904. The second PRACH mask index can indicate the ROs associated with the SSB indicated by SSB index in the PDCCH order for the additional PRACH resources (e.g., for the additional PRACH transmission of the contention-free random access resources). This field may be added only if additional PRACH resources are activated (e.g., the one or more additional ROs 904 are activated).

In some aspects, multiple PRACH mask indexes may be utilized through the implementation of additional PDCCH orders (e.g., a second PDCCH order transmitted by the network entity 802 and/or received by the UE 804). Example 900 of FIG. 9, further depicts an optional second PDCCH order 908 at a second time t2. In some aspects, to support separate SSB-to-RO mappings in case of dynamic adaptation of PRACH in the time domain and when one or more additional ROs 904 are activated, multiple PDCCH orders 906 and 908 may be transmitted. For example, a first PDCCH order 906 may be transmitted by the network entity 802 and/or received by the UE 804 at a first time t1. The first PDCCH order 906 may include the PRACH mask index and SSB index for the one or more first ROs 902. A second PDCCH order 908 may be transmitted by the network entity 802 and/or received by the UE 804 at a second time t2. The second PDCCH order 908 may include the PRACH mask index and SSB index for the one or more additional ROs 904.

To indicate that the first PDCCH order 906 corresponds to the one or more first ROs 902, a first bit value in a bit field of the first PDCCH order 906 may be used to indicate that the PRACH mask index corresponds to the one or more first ROs 902. For example, a bit value of 0 may indicate that the first PDCCH order 906 corresponds to the one or more first ROs 902. Alternatively, a bit value of 1 may indicate that the first PDCCH order 906 corresponds to the one or more second ROs (e.g., the one or more additional ROs 904).

To indicate that the second PDCCH order 908 corresponds to the one or more additional ROs 904, a first bit value in a bit field of the first PDCCH order may be used to indicate that the PRACH mask index corresponds to the one or more first ROs 902. For example, a second bit value (e.g., a bit value that is different that the first bit value) of 0 may indicate that the second PDCCH order 908 corresponds to the one or more additional ROs 904. Alternatively, a bit value of 1 may indicate that the second PDCCH order 908 corresponds to the one or more additional ROs 904. In instances where the same SSB-RO mapping is implemented, two PDCCH orders may be sent. In some instances, two PDCCH orders may be sent regardless of the kind of SSB-RO mapping or sets of SSB indexes that are defined.

In some aspects, a single PDCCH order includes the bit field. For example, a bit value of 0 may indicate that the single PDCCH order corresponds to the one or more additional ROs 904. Alternatively, a bit value of 1 may indicate that the single PDCCH order corresponds to the one or more additional ROs 904. Thus, the PRACH mask index can be applied to the one or more first ROs 902 or the one or more additional ROs 904 according to the bit field.

In some aspects, the timing of the transmission/reception of a PDCCH order may indicate which of the one or more first ROs 902 or the one or more additional ROs 904 the PDCCH order corresponds to. As depicted in example 900 of FIG. 9, for example, the first PDCCH order 906 at the first time t1 may correspond to the one or more additional ROs 904 since the earliest RO after the first PDCCH order 906 at the first time t1 is the one or more additional ROs 904. As a result, the second PDCCH order 908 may be configured to correspond to the one or more first ROs 902 since the first PDCCH order corresponds to the other ROs (e.g., the one or more additional ROs).

The transmission and/or reception of multiple PDCCH orders brings about an additional consideration. That is, the additional consideration relates to how to handle a second PDCCH order 908 that a UE 804 receives while performing a Random Access (RA) procedure based on a first PDCCH order 906 received prior to the second PDCCH order. For example, the UE 804 may receive a second PDCCH order 908 corresponding to the one or more first ROs 902 and indicating the same Random Access Preamble, uplink carrier, and PRACH mask index as a first PDCCH order 906 corresponding to the one or more additional ROs 904, where the first PDCCH order 906 triggered the Random Access procedure (e.g., the synchronization at block 814 of FIG. 8) already in progress between the UE 804 and the network entity 802. Accordingly, whether the second PDCCH order 908 or other subsequent PDCCH order trigger a new Random Access procedure interrupting one currently in process or is the second PDCCH order 908 or other subsequent PDCCH order ignored such that a new Random Access procedure is not initiated and the Random Access procedure in progress continues, involves a solution to enable consistency and stability when multiple PDCCH orders are utilized. In one aspect, the second PDCCH order 908 is ignored when the UE 804 is configured to or engaged in a Random Access procedure such that a new Random Access procedure is not initiated. In another aspect, the second PDCCH order or other subsequent PDCCH order is not treated as part of the existing Random Access procedure and a new Random Access procedure is initiated. While the aforementioned example suggests that the first Random Access procedure (e.g., the one in progress) corresponds to the one or more additional ROs 904 and the second PDCCH order corresponds to the one or more first ROs 902, the same options are applicable if correspondences between the PDCCH orders and the first ROs and additional ROs were reversed. For example, the first Random Access procedure may correspond to the one or more first ROs 902 while the second PDCCH order may correspond to the one or more additional ROs 904.

FIG. 10 depicts an example 1000 of mapping and example 1010 of remapping the SSB and ROs for dynamic adaptation of PRACH. FIG. 10 illustrates first ROs with a black fill, additional ROs with a solid outline and a diagonal fill, muted (e.g., deactivated) additional ROs with a dashed outline and diagonal fill, and a PDCCH order with a dotted fill. In FIG. 10, DCI carries a PDCCH order 1006. This PDCCH order 1006 also activates muted additional ROs (which were illustrated with the dashed outline before the PDCCH order 1006 is received) such that the muted additional ROs are available for transmission. This activation may be done using an enhanced version of the PDCCH order 1006 (e.g., an enhanced version of DCI format 1_0). For example, the PDCCH order 1006 at time t1 includes an SSB index of 1. If the SSB-to-RO mapping of example 1000 is used, the UE 804 could initiate a random access procedure at t3, which corresponds to a next RO mapped to the SSB index of 1. Example 1010, described below, illustrates how the UE 804 and/or network entity 802 can overwrite the SSB-to-RO mapping of example 1000 to reduce delay before initiating the random access procedure.

In some aspects, the UE 804 may be configured to overwrite an existing SSB-to-RO mapping. For example, as depicted in example 1000, the additional RO 1002 may have a mapping of an SSB index of 4. The UE 804 may overwrite an SSB index of the first RO (e.g., RO 1002) occurring after the DCI order to match the SSB index indicated in the PDCCH order 1006. The RO 1002 is the first RO occurring after the PDCCH order 1006 and, before overwriting the mapping, the additional RO 1002 has a mapping of an SSB index of 4. The UE 804 may remap the additional RO 1002 from the SSB index of 4 to an SSB index 1 as depicted in example 1010. Additionally, each of the subsequent additional ROs 1004 shown in example 1000 may be remapped to have respective SSB indexes continuing from the SSB index of 1 that the additional RO 1012 was remapped to. That is, the remapping is done by applying an offset to the SSB indexes mapped to the additional ROs. In some aspects, the network entity 802 may return dynamically to the default mapping after a random access procedure is done. In some aspects, since the new SSB to RO mapping allows to have ROs corresponding to the first SSB at t2, the random access procedure can start at t2 instead of t3 or t4, which enables faster response to the PDCCH order 1006.

### Example Operations of a User Equipment

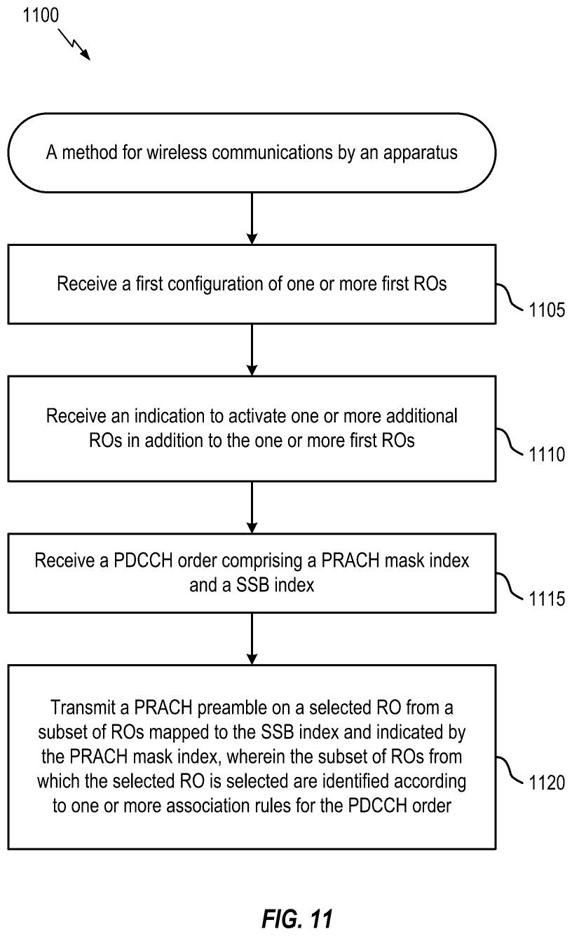

FIG. 11 shows a method 1100 for wireless communications by an apparatus, such as UE 104 of FIG. 1, UE 304 of FIG. 3, UE 504 of FIG. 5, UE 704 of FIG. 7, or UE 804 of FIG. 8.

Method 1100 begins at block 1105 with receiving a first configuration of one or more first ROs.

Method 1100 then proceeds to block 1110 with receiving an indication to activate one or more additional ROs in addition to the one or more first ROs.

Method 1100 then proceeds to block 1115 with receiving a PDCCH order comprising a PRACH mask index and a SSB index.

Method 1100 then proceeds to block 1120 with transmitting a PRACH preamble on a selected RO from a subset of ROs mapped to the SSB index and indicated by the PRACH mask index, wherein the subset of ROs from which the selected RO is selected are identified according to one or more association rules for the PDCCH order.

In some aspects, the one or more association rules indicate that the subset of ROs comprises the one or more first ROs.

In some aspects, the one or more association rules indicate that the subset of ROs comprises the one or more additional ROs.

In some aspects, the one or more association rules indicate that the subset of ROs are selected from the one or more first ROs or the one or more additional ROs based on which set of ROs, of the one or more first ROs or the one or more additional ROs, has an RO occurring earliest after the PDCCH order.

In some aspects, the selected RO is selected from the one or more additional ROs according to the one or more association rules, and the selected RO is remapped to correspond to the SSB index.

In some aspects, the one or more association rules indicate that the subset of ROs comprises an RO occurring earliest after the PDCCH order and, wherein: the RO corresponds to the SSB index, and the RO is one of: the one or more first ROs or the one or more additional ROs.

In some aspects, the PRACH mask index is usable for both the one or more first ROs and the one or more additional ROs.

In some aspects, the PRACH mask index is usable for the subset of ROs, and wherein an other set of ROs, of the one or more first ROs or the one or more additional ROs other than the subset of ROs, is associated with a second PRACH mask index, configured in the one or more memories.

In some aspects, the PRACH mask index is usable for the subset of ROs and for an other set of ROs, of the one or more first ROs or the one or more additional ROs other than the subset of ROs, based on the PRACH mask index being usable for the other set of ROs and the subset of ROs in accordance with a first set of SSB indices mapped to the subset of ROs and a second set of SSB indices mapped to the other set of ROs.

In some aspects, the subset of ROs, of the one or more first ROs or the one or more additional ROs, is associated with a first SSB to RO mapping, wherein an other set of ROs, of the one or more first ROs or the one or more additional ROs other than the subset of ROs, is associated with a second SSB to RO mapping, and wherein the other set of ROs use a second PRACH mask index configured in the one or more memories.

In some aspects, the PDCCH order comprises a plurality of PRACH mask indexes including the PRACH mask index and a second PRACH mask index, the PRACH mask index corresponds to the one or more first ROs associated with the SSB index, and the second PRACH mask index corresponds to the one or more additional ROs associated with the SSB index.

In some aspects, the PDCCH order is a first PDCCH order at a first time and the method 1100 further comprises receiving, at a second time, a second PDCCH order, wherein: a first bit value in a bit field of the first PDCCH order indicates that the PRACH mask index corresponds to the one or more first ROs, and a second bit value in the bit field of the second PDCCH order indicates that the PRACH mask index corresponds to the one or more additional ROs.

In some aspects, the PDCCH order is at a first time and the method 1100 further comprises receiving, at a second time, a second PDCCH order comprising a second PRACH mask index, wherein the PDCCH order at the first time corresponds to: one of the one or more additional ROs that occurs at a time closest to the first time, or one of the one or more first ROs that occurs at a time closest to the first time.

In some aspects, the second PDCCH order corresponds to a set of ROs, of the one or more additional ROs or the one or more first ROs, that does not correspond to the PDCCH order.

In some aspects, the PDCCH order is a first PDCCH order and the method 1100 further comprises: receiving, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and discarding the second PDCCH order.

In some aspects, the PDCCH order is a first PDCCH order and the method 1100 further comprises: receiving, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and initiating a new random access procedure based on the second PDCCH order.

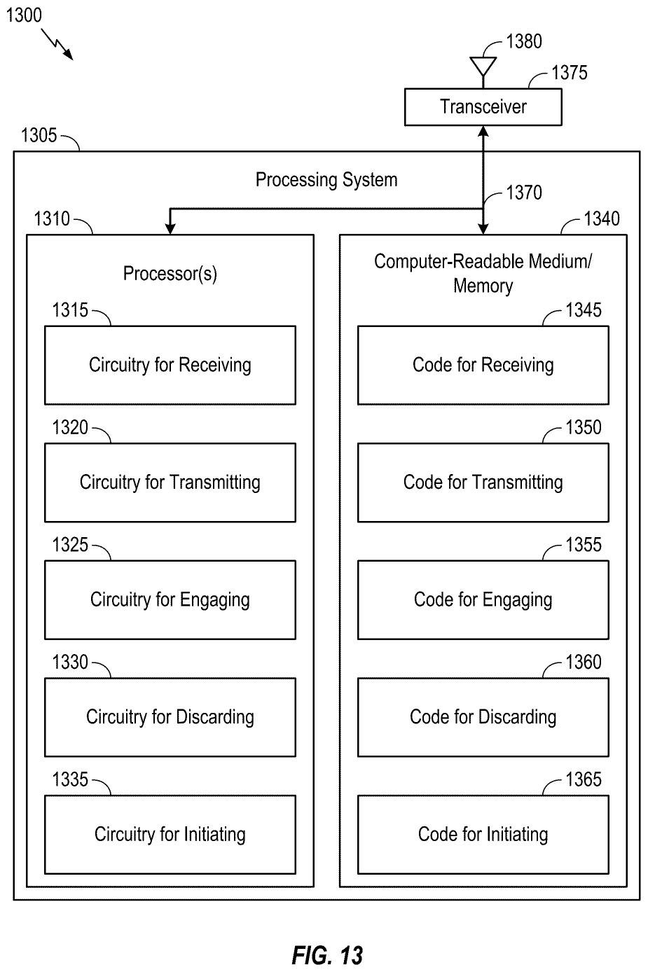

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

### Example Operations of a Network Entity

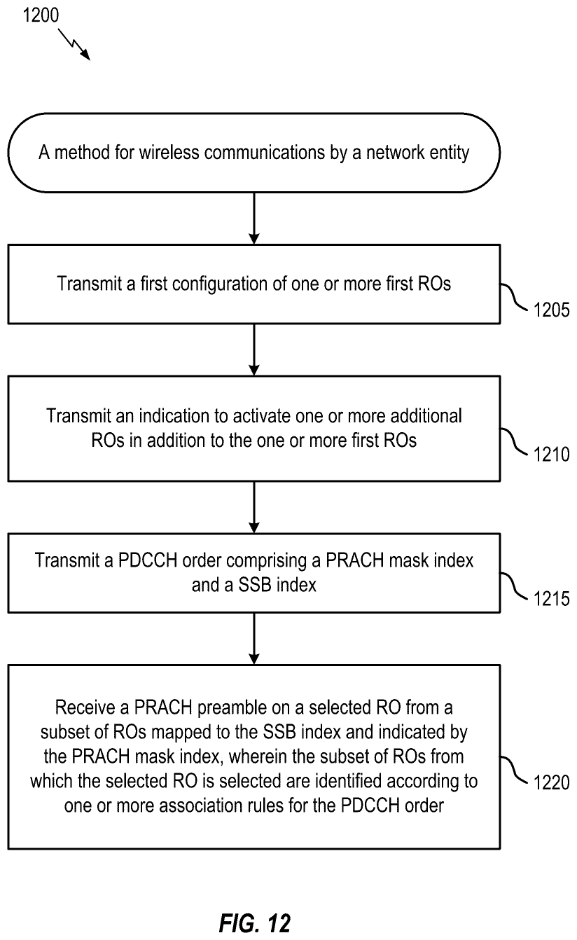

FIG. 12 shows a method 1200 for wireless communications by an apparatus, such as BS 102 of FIG. 1, a first network entity 300 or second network entity 302 of FIG. 3, a disaggregated base station as discussed with respect to FIG. 2, a network entity 502 of FIG. 5, a network entity 702 of FIG. 7, or a network entity 802 of FIG. 8.

Method 1200 begins at block 1205 with transmitting a first configuration of one or more first ROs.

Method 1200 then proceeds to block 1210 with transmitting an indication to activate one or more additional ROs in addition to the one or more first ROs.

Method 1200 then proceeds to block 1215 with transmitting a PDCCH order comprising a PRACH mask index and a SSB index.

Method 1200 then proceeds to block 1220 with receiving a PRACH preamble on a selected RO from a subset of ROs mapped to the SSB index and indicated by the PRACH mask index, wherein the subset of ROs from which the selected RO is selected are identified according to one or more association rules for the PDCCH order.

In some aspects, the one or more association rules indicate that the subset of ROs comprises the one or more first ROs.

In some aspects, the one or more association rules indicate that the subset of ROs comprises the one or more additional ROs.

In some aspects, the one or more association rules indicate that the subset of ROs are selected from the one or more first ROs or the one or more additional ROs based on which set of ROs, of the one or more first ROs or the one or more additional ROs, has an RO occurring earliest after the PDCCH order.

In some aspects, the selected RO is selected from the one or more additional ROs according to the one or more association rules, and the selected RO is remapped to correspond to the SSB index.

In some aspects, the one or more association rules indicate that the subset of ROs comprises an RO occurring earliest after the PDCCH order and, wherein: the RO corresponds to the SSB index, and the RO is one of: the one or more first ROs or the one or more additional ROs.

In some aspects, the PRACH mask index is usable for both the one or more first ROs and the one or more additional ROs.

In some aspects, the PRACH mask index is usable for the subset of ROs, and wherein an other set of ROs, of the one or more first ROs or the one or more additional ROs other than the subset of ROs, is associated with a second PRACH mask index, configured in the one or more memories.

In some aspects, the PRACH mask index is usable for the subset of ROs and for an other set of ROs, of the one or more first ROs or the one or more additional ROs other than the subset of ROs, based on the PRACH mask index being usable for the other set of ROs and the subset of ROs in accordance with a first set of SSB indices mapped to the subset of ROs and a second set of SSB indices mapped to the other set of ROs.

In some aspects, the subset of ROs, of the one or more first ROs or the one or more additional ROs, is associated with a first SSB to RO mapping, wherein an other set of ROs, of the one or more first ROs or the one or more additional ROs other than the subset of ROs, is associated with a second SSB to RO mapping, and wherein the other set of ROs use a second PRACH mask index configured in the one or more memories.

In some aspects, the PDCCH order comprises a plurality of PRACH mask indexes including the PRACH mask index and a second PRACH mask index, the PRACH mask index corresponds to the one or more first ROs associated with the SSB index, and the second PRACH mask index corresponds to the one or more additional ROs associated with the SSB index.

In some aspects, the PDCCH order is a first PDCCH order at a first time and the method 1200 further comprises transmitting, at a second time, a second PDCCH order, wherein: a first bit value in a bit field of the first PDCCH order indicates that the PRACH mask index corresponds to the one or more first ROs, and a second bit value in the bit field of the second PDCCH order indicates that the PRACH mask index corresponds to the one or more additional ROs.

In some aspects, the PDCCH order is at a first time and the method 1200 further comprises transmitting, at second time, a second PDCCH order comprising a second PRACH mask index, wherein the PDCCH order at the first time corresponds to: one of the one or more additional ROs that occurs at a time closest to the first time, or one of the one or more first ROs that occurs at a time closest to the first time.

In some aspects, the second PDCCH order corresponds a set of ROs, of the one or more additional ROs or the one or more first ROs, that does not correspond to the PDCCH order.

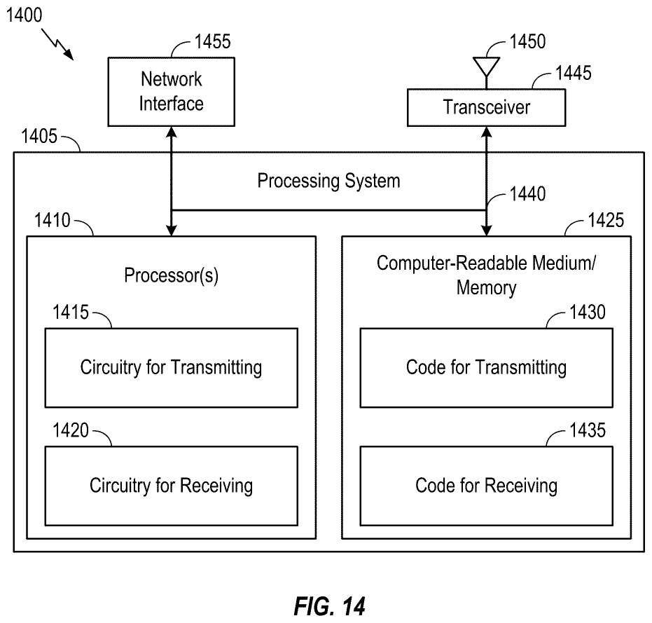

In some aspects, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative operations are possible consistent with this disclosure.

### Example Communications Devices

FIG. 13 depicts aspects of an example communications device 1300 configured for wireless communications. In some aspects, communications device 1300 is a user equipment, such as UE 104 described above with respect to FIG. 1, UE 304 described with respect to FIG. 3, UE 504 described with respect to FIG. 5, UE 704 described with respect to FIG. 7, or UE 804 described with respect to FIG. 8.

The communications device 1300 includes a processing system 1305 coupled to a transceiver 1375 (e.g., a transmitter and/or a receiver). The transceiver 1375 is configured to transmit and receive signals for the communications device 1300 via an antenna 1380, such as the various signals as described herein. The processing system 1305 may be configured to perform processing functions for the communications device 1300, including processing signals received and/or to be transmitted by the communications device 1300.

The processing system 1305 includes one or more processors 1310 and a computer-readable medium/memory 1340. In various aspects, the one or more processors 1310 may be representative of the one or more processors 318 described with respect to FIG. 3. The one or more processors 1310 are coupled to a computer-readable medium/memory 1340 via a bus 1370. In some aspects, the computer-readable medium/memory 1340 may be representative of the one or more memories 320 described with respect to FIG. 3. The computer-readable medium/memory 1340 is a non-transitory computer-readable medium/memory. In certain aspects, the computer-readable medium/memory 1340 is configured to store instructions (e.g., computer-executable code), that when executed by the one or more processors 1310, cause the one or more processors 1310 to perform the method 1100 described with respect to FIG. 11, or any aspect related to it, including any operations described in relation to FIG. 11. Note that reference to a processor performing a function of communications device 1300 may include one or more processors performing that function of communications device 1300, such as in a distributed fashion.

In the depicted example, computer-readable medium/memory 1340 stores code (e.g., executable instructions), including code for receiving 1345, code for transmitting 1350, code for engaging 1355, code for discarding 1360, and code for initiating 1365. Processing of the code 1345-1365 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1340, including circuitry for receiving 1315, circuitry for transmitting 1320, circuitry for engaging 1325, circuitry for discarding 1330, and circuitry for initiating 1335. Processing with circuitry 1315-1335 may enable and cause the communications device 1300 to perform the method 1100 described with respect to FIG. 11, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13. Means for communicating, receiving or obtaining may include the one or more transceivers 324, one or more antennas 322, and/or processing system 316 of the UE 304 illustrated in FIG. 3, transceiver 1375 and/or antenna 1380 of the communications device 1300 in FIG. 13, and/or one or more processors 1310 of the communications device 1300 in FIG. 13.

FIG. 14 depicts aspects of an example communications device configured for wireless communications. In some aspects, communications device 1400 is a network entity, such as BS 102 of FIG. 1, first network entity 300 or second network entity 302 of FIG. 3, a disaggregated base station as discussed with respect to FIG. 2, a network entity 502 of FIG. 5, a network entity 702 of FIG. 7, or a network entity 802 of FIG. 8.

The communications device 1400 includes a processing system 1405 coupled to a transceiver 1445 (e.g., a transmitter and/or a receiver) and/or a network interface 1455. The transceiver 1445 is configured to transmit and receive signals for the communications device 1400 via an antenna 1450, such as the various signals as described herein. The network interface 1455 is configured to obtain and send signals for the communications device 1400 via communications link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410 and a computer-readable medium/memory 1425. In various aspects, one or more processors 1410 may be representative of the one or more processors 308, as described with respect to FIG. 3. The one or more processors 1410 are coupled to the computer-readable medium/memory 1425 via a bus 1440. In certain aspects, the computer-readable medium/memory 1425 is configured to store instructions (e.g., computer-executable code), including code 1430 and 1435, that when executed by the one or more processors 1410, cause the one or more processors 1410 to perform the method 1200 described with respect to FIG. 12, or any aspect related to it, including any operations described in relation to FIG. 12. The computer-readable medium/memory 1425 is a non-transitory computer-readable medium/memory. Note that reference to a processor of communications device 1400 performing a function may include one or more processors of communications device 1400 performing that function, such as in a distributed fashion.

In the depicted example, the computer-readable medium/memory 1425 stores code (e.g., executable instructions), including code for transmitting 1430 and code for receiving 1435. Processing of the code 1430 and 1435 may enable and cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry for transmitting 1415 and circuitry for receiving 1420. Processing with circuitry 1415 and 1420 may enable and cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14. Means for communicating, receiving or obtaining may include the one or more transceivers 312, one or more antennas 314, and/or processing system 306 of the first network entity 300 or the second network entity 302 illustrated in FIG. 3, transceiver 1445, antenna 1450, and/or network interface 1455 of the communications device 1400 in FIG. 14, and/or one or more processors 1410 of the communications device 1400 in FIG. 14.

### EXAMPLE CLAUSES

Implementation examples are described in the following numbered clauses:

Clause 1: A method for wireless communications by an apparatus comprising: receiving a first configuration of one or more first ROs; receiving an indication to activate one or more additional ROs in addition to the one or more first ROs; receiving a PDCCH order comprising a PRACH mask index and a SSB index; and transmitting a PRACH preamble on a selected RO from a subset of ROs mapped to the SSB index and indicated by the PRACH mask index, wherein the subset of ROs from which the selected RO is selected are identified according to one or more association rules for the PDCCH order.

Clause 2: The method of Clause 1, wherein the one or more association rules indicate that the subset of ROs comprises the one or more first ROs.

Clause 3: The method of any one of Clauses 1-2, wherein the one or more association rules indicate that the subset of ROs comprises the one or more additional ROs.

Clause 4: The method of any one of Clauses 1-3, wherein the one or more association rules indicate that the subset of ROs are selected from the one or more first ROs or the one or more additional ROs based on which set of ROs, of the one or more first ROs or the one or more additional ROs, has an RO occurring earliest after the PDCCH order.

Clause 5: The method of Clause 4, wherein the selected RO is selected from the one or more additional ROs according to the one or more association rules, and the selected RO is remapped to correspond to the SSB index.

Clause 6: The method of any one of Clauses 1-5, wherein the one or more association rules indicate that the subset of ROs comprises an RO occurring earliest after the PDCCH order and, wherein: the RO corresponds to the SSB index, and the RO is one of: the one or more first ROs or the one or more additional ROs.

Clause 7: The method of any one of Clauses 1-6, wherein the PRACH mask index is usable for both the one or more first ROs and the one or more additional ROs.

Clause 8: The method of any one of Clauses 1-7, wherein the PRACH mask index is usable for the subset of ROs, and wherein an other set of ROs, of the one or more first ROs or the one or more additional ROs other than the subset of ROs, is associated with a second PRACH mask index, configured in the one or more memories.

Clause 9: The method of any one of Clauses 1-8, wherein the PRACH mask index is usable for the subset of ROs and for an other set of ROs, of the one or more first ROs or the one or more additional ROs other than the subset of ROs, based on the PRACH mask index being usable for the other set of ROs and the subset of ROs in accordance with a first set of SSB indices mapped to the subset of ROs and a second set of SSB indices mapped to the other set of ROs.

Clause 10: The method of any one of Clauses 1-9, wherein the subset of ROs, of the one or more first ROs or the one or more additional ROs, is associated with a first SSB to RO mapping, wherein an other set of ROs, of the one or more first ROs or the one or more additional ROs other than the subset of ROs, is associated with a second SSB to RO mapping, and wherein the other set of ROs use a second PRACH mask index configured in the one or more memories.

Clause 11: The method of any one of Clauses 1-10, wherein the PDCCH order comprises a plurality of PRACH mask indexes including the PRACH mask index and a second PRACH mask index, the PRACH mask index corresponds to the one or more first ROs associated with the SSB index, and the second PRACH mask index corresponds to the one or more additional ROs associated with the SSB index.

Clause 12: The method of any one of Clauses 1-11, wherein the PDCCH order is a first PDCCH order at a first time and the method further comprises: receiving, at a second time, a second PDCCH order, wherein: a first bit value in a bit field of the first PDCCH order indicates that the PRACH mask index corresponds to the one or more first ROs, and a second bit value in the bit field of the second PDCCH order indicates that the PRACH mask index corresponds to the one or more additional ROs.

Clause 13: The method of any one of Clauses 1-12, wherein the PDCCH order is at a first time and the method further comprises receiving, at a second time, a second PDCCH order comprising a second PRACH mask index, wherein the PDCCH order at the first time corresponds to: one of the one or more additional ROs that occurs at a time closest to the first time, or one of the one or more first ROs that occurs at a time closest to the first time.

Clause 14: The method of Clause 13, wherein the second PDCCH order corresponds to a set of ROs, of the one or more additional ROs or the one or more first ROs, that does not correspond to the PDCCH order.

Clause 15: The method of any one of Clauses 1-14, wherein the PDCCH order is a first PDCCH order and the method further comprises: receiving, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and discarding the second PDCCH order.

Clause 16: The method of any one of Clauses 1-15, wherein the PDCCH order is a first PDCCH order and the method further comprises: receiving, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and initiating a new random access procedure based on the second PDCCH order.

Clause 17: A method for wireless communications by a network entity comprising: transmitting a first configuration of one or more first ROs; transmitting an indication to activate one or more additional ROs in addition to the one or more first ROs; transmitting a PDCCH order comprising a PRACH mask index and a SSB index; and receiving a PRACH preamble on a selected RO from a subset of ROs mapped to the SSB index and indicated by the PRACH mask index, wherein the subset of ROs from which the selected RO is selected are identified according to one or more association rules for the PDCCH order.

Clause 18: The method of Clause 17, wherein the one or more association rules indicate that the subset of ROs comprises the one or more first ROs.

Clause 19: The method of any one of Clauses 17-18, wherein the one or more association rules indicate that the subset of ROs comprises the one or more additional ROs.

Clause 20: The method of any one of Clauses 17-19, wherein the one or more association rules indicate that the subset of ROs are selected from the one or more first ROs or the one or more additional ROs based on which set of ROs, of the one or more first ROs or the one or more additional ROs, has an RO occurring earliest after the PDCCH order.

Clause 21: The method of Clause 20, wherein the selected RO is selected from the one or more additional ROs according to the one or more association rules, and the selected RO is remapped to correspond to the SSB index.

Clause 22: The method of any one of Clauses 17-21, wherein the one or more association rules indicate that the subset of ROs comprises an RO occurring earliest after the PDCCH order and, wherein: the RO corresponds to the SSB index, and the RO is one of: the one or more first ROs or the one or more additional ROs.

Clause 23: The method of any one of Clauses 17-22, wherein the PRACH mask index is usable for both the one or more first ROs and the one or more additional ROs.

Clause 24: The method of any one of Clauses 17-23, wherein the PRACH mask index is usable for the subset of ROs, and wherein an other set of ROs, of the one or more first ROs or the one or more additional ROs other than the subset of ROs, is associated with a second PRACH mask index, configured in the one or more memories.

Clause 25: The method of any one of Clauses 17-24, wherein the PRACH mask index is usable for the subset of ROs and for an other set of ROs, of the one or more first ROs or the one or more additional ROs other than the subset of ROs, based on the PRACH mask index being usable for the other set of ROs and the subset of ROs in accordance with a first set of SSB indices mapped to the subset of ROs and a second set of SSB indices mapped to the other set of ROs.

Clause 26: The method of any one of Clauses 17-25, wherein the subset of ROs, of the one or more first ROs or the one or more additional ROs, is associated with a first SSB to RO mapping, wherein an other set of ROs, of the one or more first ROs or the one or more additional ROs other than the subset of ROs, is associated with a second SSB to RO mapping, and wherein the other set of ROs use a second PRACH mask index configured in the one or more memories.

Clause 27: The method of any one of Clauses 17-26, wherein the PDCCH order comprises a plurality of PRACH mask indexes including the PRACH mask index and a second PRACH mask index, the PRACH mask index corresponds to the one or more first ROs associated with the SSB index, and the second PRACH mask index corresponds to the one or more additional ROs associated with the SSB index.

Clause 28: The method of any one of Clauses 17-27, wherein the PDCCH order is a first PDCCH order at a first time and the method further comprises: transmitting, at a second time, a second PDCCH order, wherein: a first bit value in a bit field of the first PDCCH order indicates that the PRACH mask index corresponds to the one or more first ROs, and a second bit value in the bit field of the second PDCCH order indicates that the PRACH mask index corresponds to the one or more additional ROs.

Clause 29: The method of any one of Clauses 17-28, wherein the PDCCH order is at a first time and the method further comprises transmitting, at second time, a second PDCCH order comprising a second PRACH mask index, wherein the PDCCH order at the first time corresponds to: one of the one or more additional ROs that occurs at a time closest to the first time, or one of the one or more first ROs that occurs at a time closest to the first time.

Clause 30: The method of Clause 29, wherein the second PDCCH order corresponds a set of ROs, of the one or more additional ROs or the one or more first ROs, that does not correspond to the PDCCH order.

Clause 31: One or more apparatuses, comprising: one or more memories comprising executable instructions; and one or more processors configured to execute the executable instructions and cause the one or more apparatuses to perform a method in accordance with any one of Clauses 1-30.

Clause 32: One or more apparatuses configured for wireless communications, comprising: one or more memories; and one or more processors, coupled to the one or more memories, configured to cause the one or more apparatuses to perform a method in accordance with any one of Clauses 1-30.

Clause 33: One or more apparatuses configured for wireless communications, comprising: one or more memories; and one or more processors, coupled to the one or more memories, configured to perform a method in accordance with any one of Clauses 1-30.

Clause 34: One or more apparatuses, comprising means for performing a method in accordance with any one of Clauses 1-30.

Clause 35: One or more non-transitory computer-readable media comprising executable instructions that, when executed by one or more processors of one or more apparatuses, cause the one or more apparatuses to perform a method in accordance with any one of Clauses 1-30.

Clause 36: One or more computer program products embodied on one or more computer-readable storage media comprising code for performing a method in accordance with any one of Clauses 1-30.

Clause 37: One or more apparatuses configured for wireless communications, comprising: a processing system that includes one or more processors and one or more memories coupled with the one or more processors, the processing system configured to cause the one or more apparatuses to perform a method in accordance with any one of Clauses 1-30.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising: a processing system that includes one or more processors and one or more memories coupled with the one or more processors, the processing system configured to cause the apparatus to:
receive a first configuration of one or more first random access channel (RACH) occasions (ROs);
receive an indication to activate one or more additional ROs in addition to the one or more first ROs;
receive a physical downlink control channel (PDCCH) order comprising a physical random access channel (PRACH) mask index and a synchronization signal block (SSB) index; and
transmit a PRACH preamble on a selected RO from a subset of ROs mapped to the SSB index and indicated by the PRACH mask index, wherein the subset of ROs from which the selected RO is selected are identified according to one or more association rules for the PDCCH order.

2. The apparatus of claim 1, wherein the one or more association rules indicate that the subset of ROs comprises the one or more first ROs.

3. The apparatus of claim 1, wherein the one or more association rules indicate that the subset of ROs comprises the one or more additional ROs.

4. The apparatus of claim 1, wherein the one or more association rules indicate that the subset of ROs are selected from the one or more first ROs or the one or more additional ROs based on which set of ROs, of the one or more first ROs or the one or more additional ROs, has an RO occurring earliest after the PDCCH order.

5. The apparatus of claim 4, wherein the selected RO is selected from the one or more additional ROs according to the one or more association rules, and the selected RO is remapped to correspond to the SSB index.

6. The apparatus of claim 1, wherein the one or more association rules indicate that the subset of ROs comprises an RO occurring earliest after the PDCCH order and, wherein:
the RO corresponds to the SSB index, and
the RO is one of: the one or more first ROs or the one or more additional ROs.

7. The apparatus of claim 1, wherein the PRACH mask index is usable for both the one or more first ROs and the one or more additional ROs.

8. The apparatus of claim 1, wherein the PRACH mask index is usable for the subset of ROs, and wherein an other set of ROs, of the one or more first ROs or the one or more additional ROs other than the subset of ROs, is associated with a second PRACH mask index, configured in the one or more memories.

9. The apparatus of claim 1, wherein the PRACH mask index is usable for the subset of ROs and for an other set of ROs, of the one or more first ROs or the one or more additional ROs other than the subset of ROs, based on the PRACH mask index being usable for the other set of ROs and the subset of ROs in accordance with a first set of SSB indexes mapped to the subset of ROs and a second set of SSB indexes mapped to the other set of ROs.

10. The apparatus of claim 1, wherein the subset of ROs, of the one or more first ROs or the one or more additional ROs, is associated with a first SSB to RO mapping, wherein an other set of ROs, of the one or more first ROs or the one or more additional ROs other than the subset of ROs, is associated with a second SSB to RO mapping, and wherein the other set of ROs use a second PRACH mask index configured in the one or more memories.

11. The apparatus of claim 1, wherein the PDCCH order comprises a plurality of PRACH mask indexes including the PRACH mask index and a second PRACH mask index, the PRACH mask index corresponds to the one or more first ROs associated with the SSB index, and the second PRACH mask index corresponds to the one or more additional ROs associated with the SSB index.

12. The apparatus of claim 1, wherein the PDCCH order is a first PDCCH order at a first time and the processing system is configured to cause the apparatus to:
receive, at a second time, a second PDCCH order, wherein:
a first bit value in a bit field of the first PDCCH order indicates that the PRACH mask index corresponds to the one or more first ROs, and
a second bit value in the bit field of the second PDCCH order indicates that the PRACH mask index corresponds to the one or more additional ROs.

13. The apparatus of claim 1, wherein the PDCCH order is at a first time and the processing system is configured to cause the apparatus to:
receive, at a second time, a second PDCCH order comprising a second PRACH mask index, wherein the PDCCH order at the first time corresponds to: one of the one or more additional ROs that occurs at a time closest to the first time, or one of the one or more first ROs that occurs at a time closest to the first time.

14. The apparatus of claim 13, wherein the second PDCCH order corresponds to a set of ROs, of the one or more additional ROs or the one or more first ROs, that does not correspond to the PDCCH order.

15. The apparatus of claim 1, wherein the PDCCH order is a first PDCCH order and the processing system is configured to cause the apparatus to:
receive, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and
discard the second PDCCH order.

16. The apparatus of claim 1, wherein the PDCCH order is a first PDCCH order and the processing system is configured to cause the apparatus to:
receive, at a second time, a second PDCCH order comprising the PRACH mask index and associated with a same random access preamble and uplink carrier as the first PDCCH order, wherein at the second time, the apparatus is configured to engage or is engaged in a random access procedure corresponding to the first PDCCH order; and
initiate a new random access procedure based on the second PDCCH order.

17. An apparatus configured for wireless communications, comprising: a processing system that includes one or more processors and one or more memories coupled with the one or more processors, the processing system configured to cause a network entity to:
transmit a first configuration of one or more first random access channel (RACH) occasions (ROs);
transmit an indication to activate one or more additional ROs in addition to the one or more first ROs;
transmit a physical downlink control channel (PDCCH) order comprising a physical random access channel (PRACH) mask index and a synchronization signal block (SSB) index; and
receive a PRACH preamble on a selected RO from a subset of ROs mapped to the SSB index and indicated by the PRACH mask index, wherein the subset of ROs from which the selected RO is selected are identified according to one or more association rules for the PDCCH order.

18. The apparatus of claim 17, wherein the one or more association rules indicate at least one of:
the subset of ROs comprises the one or more first ROs,
the subset of ROs comprises the one or more additional ROs,
the subset of ROs are selected from the one or more first ROs or the one or more additional ROs based on which set of ROs, of the one or more first ROs or the one or more additional ROs, has an RO occurring earliest after the PDCCH order, or
the subset of ROs comprises an RO occurring earliest after the PDCCH order and, wherein:
the RO corresponds to the SSB index, and
the RO is one of: the one or more first ROs or the one or more additional ROs.

19. The apparatus of claim 18, wherein the selected RO is selected from the one or more additional ROs according to the one or more association rules, and the selected RO is remapped to correspond to the SSB index.

20. A method for wireless communications by an apparatus comprising:
receiving a first configuration of one or more first random access channel (RACH) occasions (ROs);
receiving an indication to activate one or more additional ROs in addition to the one or more first ROs;
receiving a physical downlink control channel (PDCCH) order comprising a physical random access channel (PRACH) mask index and a synchronization signal block (SSB) index; and
transmitting a PRACH preamble on a selected RO from a subset of ROs mapped to the SSB index and indicated by the PRACH mask index, wherein the subset of ROs from which the selected RO is selected are identified according to one or more association rules for the PDCCH order.
